(19) United States
(12) Patent Application Publication
(10) Pub. No.: US 2014/0006056 A1
(43) Pub. Date: Jan. 2, 2014

(54) Method for Collecting Patient's Physical Sign Data and Mobile Nusing System

(71) Applicant: GE Medical Systems Global Technology Company, LLC, Waukesha, WI (US)

(72) Inventors: Rui Yang, Beijing (CN); Yan Li, Beijing (CN)

(21) Appl. No.: 13/929,988

(22) Filed: Jun. 28, 2013

(30) Foreign Application Priority Data
Jun. 29, 2012 (CN) 201210225047.9

(51) Int. Cl. G06Q 50/24; G06Q 10/00

(52) U.S. Cl. CPC G06Q 50/24; G06Q 10/00
USPC 705/3

(57) ABSTRACT

A method for collecting a patient's physical sign data, the method comprising providing a mobile nursing system comprising a human-machine interface, collecting the physical sign data by operating the mobile nursing system, generating optional icons representing each of the patient's physical signs in the human-machine interface when a user triggers a command to collect the physical sign data via the human-machine interface, such that the user can select a physical sign of the physical signs to be recorded, and generating an arc value slider providing a corresponding value range for the selected physical sign in the human-machine interface when the user has selected the selected physical sign of the physical signs to be recorded, such that the user can select an observed value from the corresponding value range for the selected physical sign via the arc value slider after observing the selected physical sign.

### TECHNICAL FIELD

Embodiments of the present invention relate to a method for collecting a patient's physical sign data and a mobile nursing system.

### BACKGROUND OF THE INVENTION

Ideally, a system for recording a patient's physical signs should be rapid enough to conduct a real-time record. However, the current mobile input system for a patient's physical sign data is a manual input system. By means of a soft keyboard of the input system, a user manually enters physical signal data values one by one, such that the current physical sign collection system is of extremely poor usability and remarkably low efficiency, and is error-vulnerable when data is manually entered. In addition, since the screen of the mobile device is relatively small, its input control console and soft keyboard are so small that these components are of quite poor readability, and are specially demanding in operation.

For example, in China, a nurse needs to collect a patient's physical sign data at least four to six times each day, which poses a heavy workload to the nurse. As can be expected, errors will inevitably occur when the nurse manually inputs so many patient data in a short time period via a physical sign collection system of very poor usability.

Therefore, there is a need for a physical sign data collection method or device for rapidly and precisely inputting a patient's physical sign data and concurrently allowing for a review over the data entry.

### SUMMARY OF THE INVENTION

In order to solve one or more of the above problems, the present invention provides a mobile nursing system comprising an arc value slider generation unit in a patient's data recording unit and a method for collecting the patient's data via such a mobile nursing system.

According to an embodiment of the present invention, a method for collecting a patient's physical sign data via a mobile nursing system is provided. The method comprises generating optional icons which represent each physical sign in a human-machine interface when a user triggers a command to collect the patient's physical sign data via the human-machine interface of the mobile nursing system, such that the user can select a type of the patient's physical sign to be recorded. The method further comprises generating an arc value slider which provides a corresponding value range for the physical sign in the human-machine interface when the user has selected the type of the patient's physical sign to be recorded, such that the user can select an observed value from the corresponding value range for the physical sign via the arc value slider after observing the patient's physical sign.

According to an embodiment of the present invention, the arc value slider comprises a first arc value slider and a second arc value slider, wherein the first arc value slider provides the physical sign with a corresponding general value range and the second arc value slider provides the physical sign with a corresponding accurate value range.

According to an embodiment of the present invention, the second arc value slider provides the physical sign with the accurate value range corresponding to a general value after the user selects the general value of the physical sign from the first arc value slider.

According to an embodiment of the present invention, the first arc value slider and the second arc value slider are oriented oppositely in the human-machine interface and their arcs are bent in opposite directions, and the first arc value slider and the second arc value slider are spaced in a way to facilitate the user to concurrently operate both the first arc value slider and the second arc value slider with one hand.

According to an embodiment of the present invention, both the first arc value slider and the second arc value slider are composed of a plurality of segments, wherein each segment of the first arc value slider represents a subinterval within the general value range and each segment of the second arc value slider represents an accurate value within the accurate value range.

According to an embodiment of the present invention, corresponding values are selected for the observed physical sign by selecting segments of the first arc value slider and the second arc value slider.

According to an embodiment of the present invention, the method further comprises generating the patient's data record time options in the human-machine interface of the mobile nursing system when the user saves the selected physical sign value, such that the user can review all the physical sign data recorded in the nursing record time.

According to an embodiment of the present invention, a mobile nursing system is provided. The mobile nursing system comprises a human-machine interface, wherein a user interacts with the mobile nursing system via the human-machine interface and a patient's physical sign data recording unit, operated by the user to record the physical sign data of the patient. The patient's physical sign data recording unit comprises an arc value slider generation unit for generating an arc value slider in the human-machine interface when the user has selected a type of the patient's physical sign to be recorded via the human-machine interface. The arc value slider provides a corresponding value range for the selected physical sign, such that the user can select an observed value from the corresponding value range for the physical sign after observing the patient's physical sign.

According to an embodiment of the present invention, the arc value slider generation unit is configured such that the arc value slider is generated to comprise a first arc value slider and a second arc value slider, wherein the first arc value slider is arranged to provide a corresponding general value range for the physical sign, while the second arc value slider is arranged to provide a corresponding accurate value range for the physical sign.

According to an embodiment of the present invention, the arc value slider generation unit is further configured such that the second arc value slider shows the accurate value range corresponding to a general value after the user selects the general value of the physical sign from the first arc value slider.

According to an embodiment of the present invention, the arc value slider generation unit is further configured such that the first arc value slider and the second arc value slider are generated to be oriented oppositely in the human-machine interface and have their arcs bent in opposite directions and the first arc value slider and the second arc value slider are arranged to be spaced in a way to facilitate the user to concurrently operate both the first arc value slider and the second arc value slider with one hand.

According to an embodiment of the present invention, the arc value slider is further configured such that both the first arc value slider and the second arc value slider are generated to be composed of a plurality of segments, wherein each segment of the first arc value slider represents a subinterval within the general value range and each segment of the second arc value slider represents an accurate value within the accurate value range.

According to an embodiment of the present invention, different positions of each segment of the first arc value slider represent different general values in the subinterval represented by the segment.

According to an embodiment of the present invention, the patient's physical sign data recording unit further comprises a record time list generation unit being configured to generate or update the record time list comprising all the physical sign data record time when the user saves the recorded physical sign data of the patient by operating the human-machine interface, wherein each record time in the record time list corresponds to all the physical sign data recorded in the record time.

According to an embodiment of the present invention, the record time list generation unit is further configured to present the record time list to the user via the human-machine interface, such that the user can select a particular record time to review all the physical sign data recorded in the record time.

According to an embodiment of the present invention, the mobile nursing system further comprises a common response unit for providing the user with a common response list directed to nursing information such that the user can select a common response and reply rapidly.

Through the mobile nursing system and the method for collecting a patient's physical sign data of the invention, the input speed of a patient's physical sign data can be increased by fifty percent, and input errors can be considerably reduced by providing each physical sign of a human body with a value range.

### BRIEF DESCRIPTION OF THE DRAWINGS

The disclosed contents of the present invention will become better understood when the following description is read with reference to the accompanying drawings, wherein:

FIG. 1 is a screenshot illustrating a physical sign collection window for a mobile nursing system according to an embodiment of the present invention; and

FIG. 2 is a screenshot illustrating a physical sign collection window showing newly added record time items according to an embodiment of the present invention.

### DETAILED DESCRIPTION OF THE INVENTION

Hereinafter, embodiments of the present invention will be detailed, but the invention is not limited to the following embodiments.

An embodiment of the present invention improves a mobile nursing system for collecting a patient's physical sign data and allowing for review and processing of the patient's data, and meanwhile, creates a new method for collecting a patient's physical sign data.

An embodiment of the present invention shows an improved system and mode for inputting a patient's physical sign data by improving the mobile nursing system, thereby increasing input speed and reducing input errors.

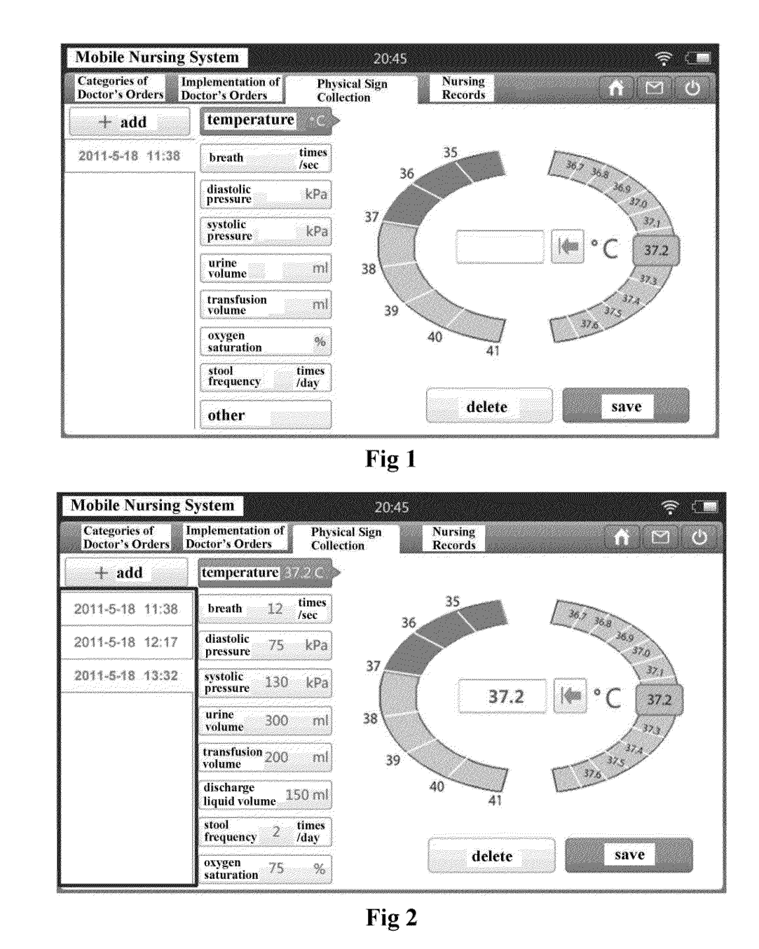

A mobile nursing system, according to an embodiment of the present invention, comprises a human-machine interface, wherein a user interacts with the mobile nursing system via the human-machine interface and a patient's physical sign data recording unit operated by the user to record the physical sign data of the patient. The human-machine interface is shown on the display of a mobile device carrying and realizing the mobile nursing system. FIG. 1 shows a screenshot of the human-machine interface according to an embodiment of the present invention. As shown in FIG. 1, the human-machine interface may be a physical sign collection window. In the physical sign window, on the left-most region is shown a button “+add” which is pressed to trigger a command to collect new patient's physical sign data. On the right side of the button “+add”, they are a plurality of optional buttons arranged in a column and representing the patient's physical sign types, which buttons comprise “temperature”, “breath”, “diastolic pressure”, “systolic pressure”, “urine volume”, “transfusion volume”, “oxygen saturation”, “stool frequency” and “other”, etc. The user may select to press these buttons to select physical sign types to be recorded. In FIG. 1, the physical sign “temperature” has been selected, which shows that the user is in a position to input an observed patient's temperature data into the mobile nursing system.

In order to improve the physical sign data input mode of the mobile nursing system, a patient's physical sign data recording unit according to an embodiment of the present invention comprises an arc value slider generation unit for generating an arc value slider (as shown by two arc icons on the right side of the physical sign type button in FIG. 1) in the human-machine interface when the user has selected a type of the patient's physical sign to be recorded via the human-machine interface. The arc value slider provides a corresponding value range for the selected physical sign, such that the user can select an observed value from the corresponding value range for the physical sign after observing the patient's physical sign.

According to an embodiment of the present invention, for the sake of a user's convenience in selecting physical sign values, the arc value slider generation unit is configured such that the arc value slider is generated to comprise a first arc value slider and a second arc value slider, wherein the first arc value slider is arranged to provide a corresponding general value range for the physical sign, while the second arc value slider is arranged to provide a corresponding accurate value range for the physical sign. The arc value slider generation unit is further configured such that the first arc value slider and the second arc value slider are generated to be oriented oppositely in the human-machine interface and have their arcs bent in opposite directions; and the first arc value slider and the second arc value slider are arranged to be spaced in a way to facilitate the user to concurrently operate both the first arc value slider and the second arc value slider with one hand, as shown by the two arc value sliders in FIG. 1. In FIG. 1, as for the selected physical sign “temperature”, the first arc value slider (i.e., the slider on the left side of the two arcs) exhibits the temperature range from 34° C. to 41° C. for the user to choose from, which is the range a human's body temperature generally falls into.

In an embodiment of the present invention, the first arc value slider can be generated to be composed of a plurality of segments arranged to be arc-shaped, wherein each segment represents a subinterval of the general value range of the physical sign. As shown in FIG. 1, the left-sided first arc value slider consists of seven segments respectively representing the general value intervals of 34° C.-35° C., 35° C.-36° C., 36° C.-37° C., 37° C.-38° C., 38° C.-39° C., 39° C.-40° C. and 40° C.-41° C. According to an embodiment of the present invention, each of the segments can further be subdivided, and different positions of each subdivided segment represent different general values in the subinterval indicated by the segment.

Having observed the physical sign to be recorded, the user may select a value corresponding to the observed physical sign value by selecting a position of one or some segments of the first arc value slider, thereby recording the physical sign value. For example, the user can move their finger across the arc value slider. When the finger stays at or presses a certain position of one or some segments, it means selecting the general value which the position corresponds to. In the embodiment of FIG. 1, the position which the user's finger stays at or presses is between the segment 36° C.-37° C. and the segment 37° C.-38° C. In response to the user's selection within the general value range of the first arc value slider, the arc value slider generation unit is configured such that the second arc value slider provides an accurate value range corresponding to the selected general value interval for the user to select from. Likewise, the arc value slider generation unit is also configured such that the second arc value slider consists of a plurality of segments each of which represents an accurate value within the accurate value range. For instance, in FIG. 1, a plurality of segments of the right-sided second arc value slider show the accurate value range from 36.7° C. to 37.6° C. The user can move another finger across the second arc value slider and make another finger stay at or press the segment corresponding to the accurate value consistent with the observed physical sign value, thereby recording the observed physical sign value. For example, in FIG. 1, when the user's finger stays at or presses the segment representing 37.2° C., it records the observed patient's body temperature 37.2° C. Following a selection of the physical sign value to be recorded, the user can press the button “save” on the lower right corner of the window so that the physical sign value can be saved into the server of the mobile nursing system.

Having saved the observed value of a physical sign, the user can continue to select another physical sign type and repeat a record process similar to the afore-mentioned process until all the observed physical sign data have been recorded.

In the above embodiment, selection of the value of the arc value slider is described to be realized in the way that the finger stays at or presses a certain position of the value slider. It can be appreciated that the selection of the value of the arc value slider can also be realized in other manners. For example, the arc value slider generation unit can be configured to generate the arc value slider (for example, the first and second arc value sliders in FIG. 1) to be slidable such that the user can slide the arc value slider with their finger, wherein the arc value slider position aligned to a particular position of the window (for example, the particular position can be displayed on the window in the form of an arrow) is considered to have been selected.

Via the previously described arc value slider generation unit and/or the mobile nursing system comprising the unit, a user can input a patient's physical sign data through selection, without having to enter all the digits of the physical sign values via a soft keyboard, such that the input speed of the patient's data is increased considerably. Additionally, since the arc value slider provides a value range of each physical sign for the user to select from, input errors resulting from manual digit input can be avoided, thereby greatly reducing an error rate in recording physical sign data. Still additionally, the value slider of the present invention is an arc, which conforms to human engineering, i.e., facilitates the user's operation and increases usability and efficiency of the system. Also, an embodiment of the present invention designs an appropriate distance between the first arc value slider and the second arc value slider, which allows the user to record physical sign data with one hand. As compared with the traditional value input operation (pressing digits in a key soft keyboard with two hands), the design provides novel interaction which involves locating or selecting the physical sign values with two fingers, thereby allowing a user (for example, a nurse) to easily and efficiently collect data with one hand while releasing the other hand.

Furthermore, in the mobile nursing system according to an embodiment of the present invention, the patient's physical sign data recording unit further comprises a record time list generation unit being configured to generate or update the record time list comprising all the physical sign data record time when the user saves the recorded physical sign data of the patient by operating the human-machine interface, wherein each record time in the record time list corresponds to all the physical sign data recorded in the record time.

When the user has saved the physical sign data into the server by pressing the button “save”, the record time list in the physical sign collection window will be updated and the newly added record time items will be displayed. As shown in FIG. 2, the physical sign collection window shows one display example of the record time list which consists of a plurality of record time items. The user can press a record time item desired to be reviewed, and all the physical sign data recorded in the record time will be shown on the right side of the time list (as shown in FIG. 2), which provides an access to reviewing the physical sign data.

According to an embodiment of the present invention, the user can receive and transmit short nursing messages via the mobile nursing system, which differs from daily communication in that when receivers capture new nursing-related message in a hospital via a mobile nursing system, they will rapidly give some typical responses on the basis of communication oriented towards ordinary tasks. In most cases, if a task request is clear enough, receivers will directly process the task and give a simple response, for they rarely expend too much time in repeated communication with the transmitter. According to an embodiment of the present invention, the mobile nursing system further comprises a common response unit for providing the user with a common response list directed to nursing information such that the user can select a common response and reply rapidly. The common response unit supports receivers to give a simple response to the message captured. Thus, interaction between the transmitter and the receivers becomes more efficient in some degree, thereby ultimately greatly increasing the communication rate.

In the patient's physical sign data collection method of an embodiment of the present invention, the mobile nursing system generates optional icons representing each physical sign in a human-machine interface when a user triggers a command to collect the patient's physical sign data via the human-machine interface of the mobile nursing system (for example, by pressing the button “+add” in the physical sign collection window), such that the user can select a type of the patient's physical sign to be recorded. The mobile nursing system generates an arc value slider providing a corresponding value range for the physical sign in the human-machine interface when the user has selected the type of the patient's physical sign to be recorded, such that the user can select an observed value from the corresponding value range for the physical sign via the arc value slider after observing the patient's physical sign. After selecting the physical sign value, the user can save the selected physical sign value into the server by pressing the button “save” in the window.

Hereinafter, the method of collecting the patient's physical sign data is explained by giving an example that the user records the patient's body temperature data via the mobile nursing system.

In an embodiment of the present invention, the nurse captures the patient's physical sign data at nine o'clock every morning. The nurse triggers a command to collect the patient's new physical sign data by pressing the button “+add” in the physical sign collection window of the human-machine interface of the mobile nursing system.

In a default setting, the body temperature collection page will be shown, which means that the user selects the physical sign type of body temperature. Then, the arc value slider in the window will provide a reference value range of the body temperature for the nurse to select from. The user smoothly slides with a finger on the first arc value slider to locate the general value 37° C. of the body temperature. Meanwhile, the user locates the value after the decimal point with another finger within the second arc value slider, i.e., selects 37.2° C. The value of the second arc value slider is auto-associated with the first arc value slider. When the user has located a general value in the first arc value slider, the value range within the second arc value slider will be automatically adjusted to be the accurate value range corresponding to the general value.

Having selected 37.2° C., the nurse stores data in the background server of the system by pressing the button “save” in the window. In an embodiment of the present invention, the user presses the button “save”. After the data is successfully saved, the record time list in the window will be updated, wherein the record time list comprises the newly added record time item. The user can press these record time items so as to review the previously captured data.

In an embodiment of the present invention, the mobile nursing system further offers a soft keyboard in the physical sign collection window to the user for alternative selection. If necessary, the user can directly input data values via the soft keyboard. In an embodiment of the present invention, the soft keyboard is located in the central region between the two arc value sliders.

Although the specific embodiments of the present invention have been described hereinabove in conjunction with the drawings, various changes, modifications or functionally equivalent substitutions to the present invention are conceivable to those skilled in the art within the spirit and scope of the invention. It is, therefore, to be understood that the appended claims are intended to cover all such changes, modifications and functionally equivalent substitutions as fall within the spirit and scope of the invention.

What is claimed is:

1. A method for collecting a patient's physical sign data, the method comprising:
providing a mobile nursing system comprising a human-machine interface;
collecting the physical sign data by operating the mobile nursing system;
generating optional icons representing each of the patient's physical signs in the human-machine interface when a user triggers a command to collect the physical sign data via the human-machine interface, such that the user can select a physical sign of the physical signs to be recorded; and
generating an arc value slider providing a corresponding value range for the selected physical sign in the human-machine interface when the user has selected the selected physical sign of the physical signs to be recorded, such that the user can select an observed value from the corresponding value range for the selected physical sign via the arc value slider after observing the selected physical sign.

2. The method according to claim 1, wherein the arc value slider comprises a first arc value slider and a second arc value slider, wherein the first arc value slider is configured to provide the selected physical sign with a corresponding general value range while the second arc value slider is configured to provide the selected physical sign with a corresponding accurate value range.

3. The method according to claim 2, wherein the second arc value slider is further configured to provide the selected physical sign with the corresponding accurate value range after the user selects a general value from the first arc value slider, wherein the corresponding accurate value range corresponds to the general value.

4. The method according to claim 2, wherein the first arc value slider and the second arc value slider are oriented oppositely in the human-machine interface, an arc of the first arc value slider and an arc of the second arc value slider are bent in opposite directions, and the first arc value slider and the second arc value slider are spaced in a way to facilitate the user to concurrently operate both the first arc value slider and the second arc value slider with one hand.

5. The method according to claim 2, wherein each of the first arc value slider and the second arc value slider comprises a plurality of segments, wherein each segment of the first arc value slider represents a subinterval within the corresponding general value range, and each segment of the second arc value slider represents a subinterval within the corresponding accurate value range.

6. The method according to claim 5, wherein the general value and a corresponding accurate value are selected for the observed selected physical sign by selecting a segment of the first arc value slider and a segment of the second arc value slider.

7. The method according to claim 1, further comprising:
generating a data record time option in the human-machine interface when the user saves a physical sign data corresponding to the selected physical sign, such that the user can review all of the physical sign data recorded according to the data record time.

8. A mobile nursing system, comprising:
a human-machine interface, wherein a user interacts with the mobile nursing system via the human-machine interface; and
a patient's physical sign data recording unit, operated by the user to record physical sign data of a patient,
wherein the patient's physical sign data recording unit comprises an arc value slider generation unit configured to generate an arc value slider in the human-machine interface when the user has selected a physical sign of the patient's physical signs to be recorded via the human-machine interface, the arc value slider providing a corresponding value range for the selected physical sign, such that the user can select an observed value from the corresponding value range for the selected physical sign after observing the selected physical sign from the patient.

9. The mobile nursing system according to claim 8, wherein the arc value slider generation unit is further configured to generate a first arc value slider and a second arc value slider, wherein the first arc value slider is configured to provide a corresponding general value range for the selected physical sign while the second arc value slider is configured to provide a corresponding accurate value range for the selected physical sign.

10. The mobile nursing system according to claim 9, wherein the second arc value slider is configured to show the corresponding accurate value range after the user selects a general value from the first arc value slider, wherein the corresponding accurate value range corresponds to the general value.

11. The mobile nursing system according to claim 9, wherein the first arc value slider and the second arc value slider are oriented oppositely in the human-machine interface, an arc of the first arc value slider and an arc of the second arc value slider are bent in opposite directions, and the first arc value slider and the second arc value slider are spaced in a way to facilitate the user to concurrently operate both the first arc value slider and the second arc value slider with one hand.

12. The mobile nursing system according to claim 9, wherein each of the first arc value slider and the second arc value slider comprises a plurality of segments, wherein each segment of the first arc value slider represents a subinterval within the corresponding general value range and each segment of the second arc value slider represents an accurate value within the corresponding accurate value range.

13. The mobile nursing system according to claim 9, wherein different positions of each segment of the first arc value slider represent different general values in the subinterval represented by the segment.

14. The mobile nursing system according to claim 8, wherein the patient's physical sign data recording unit further comprises a record time list generation unit configured to generate or update a record time list comprising all physical sign data record time when the user saves the recorded physical sign data of the patient by operating the human-machine interface, wherein each of the physical sign data record time in the record time list corresponds to all physical sign data recorded in a respective record time.

15. The mobile nursing system according to claim 14, wherein the record time list generation unit is further configured to present the record time list to the user via the human-machine interface, such that the user can select a particular record time to review all physical sign data recorded in the particular record time.

16. The mobile nursing system according to claim 8, further comprising a common response unit configured to provide the user with a common response list directed to nursing information such that the user can select a common response and reply rapidly.
